(19) United States
(12) Patent Application Publication
(10) Pub. No.: US 2026/0129452 A1
(43) Pub. Date: May 7, 2026

(54) ROGUE AP DETECTION AND SIGNALING WITHIN A SEAMLESS MOBILITY DOMAIN

(71) Applicant: Cisco Technology, Inc., San Jose, CA (US)

(72) Inventors: Binita GUPTA, San Diego, CA (US); Brian D. HART, Sunnyvale, CA (US); Stephen M. ORR, Wallkill, NY (US); Malcolm M. SMITH, Richardson, TX (US); Indermeet S. GANDHI, San Jose, CA (US)

(21) Appl. No.: 19/242,861

(22) Filed: Jun. 18, 2025

Related U.S. Application Data
(60) Provisional application No. 63/715,487, filed on Nov. 1, 2024.

(51) Int. Cl. H04W 12/122

(52) U.S. Cl. CPC H04W 12/122

(57) ABSTRACT

Detection of rogue access points (APs) through an AP that is associated with a mobility domain in a network. Unvalidated APs that attempt to join the network may be validated by another AP that is associated with the network. The unvalidated and associated APs may exchange signatures to determine if the unvalidated AP knows a key associated with the network. If the unvalidated AP does not know the key, the unvalidated AP is not validated for the network. The AP that was doing the validation may transmit a message to devices on the network indicating a rogue AP, the unvalidated AP, is attempting to join the network.

### CROSS-REFERENCE TO RELATED APPLICATIONS

This application claims benefit of U.S. provisional patent application Ser. No. 63/715,487 filed Nov. 1, 2024. The aforementioned related patent application is herein incorporated by reference in its entirety.

### TECHNICAL FIELD

Embodiments presented in this disclosure generally relate to detecting rogue access points. More specifically, embodiments disclosed herein relate to detection of rogue access points by authenticating access points that advertise as being part of a mobility domain.

### BACKGROUND

To provide smooth roaming and mobility across a Wi-Fi network, clients can create a “secure association” with an extended service set (ESS) represented by a Seamless Mobility Domain (SMD), instead of associating with a single Access Point (AP) within the ESS. Such architecture can enable a client to roam seamlessly between APs without requiring reassociation and re-establishment of contexts with a new AP, since the client associates with the SMD that is associated with the APs of the ESS.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a block diagram of an environment with a mobility domain that has access points and a rogue access point that attempts to mimic one of the access points, according to one embodiment.

FIG. 2 depicts a flowchart of a method for verifying an access point using another access point in a mobility domain, according to one embodiment.

FIG. 3 depicts a flowchart of a method for verifying an access point using a client device, according to one embodiment.

FIG. 4 depicts a flowchart of a method for associating an access point to a mobility domain, according to one embodiment.

FIG. 5 depicts a flowchart for an example method for verifying an unvalidated AP with a verified AP, according to one embodiment.

FIG. 6 depicts an example network device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes receiving, on a first access point associated with a mobility domain in a network, a first mobility domain signature from a second access point. The method further includes communicating, from the first access point to the second access point, a first nonce generated by the first access point. The method further includes receiving, on the first access point, a second mobility domain signature and a second nonce from the second access point and evaluating, on the first access point, a mobility domain validation of the second access point based on verification of the second mobility domain signature. The embodiments presented in this disclosure further include a system and a non-transitory computer-readable medium.

### Example Embodiments

This disclosure relates to validation of an unvalidated access point (AP) that purports to be associated with a mobility domain (e.g., an AP that advertises itself as part of the mobility domain, though it may or may not actually be a legitimate member of the domain). In one embodiment, the unvalidated AP is verified by another AP that is already associated with the mobility domain. The unvalidated AP exchanges nonces with the associated AP along with exchanging mobility domain signatures to verify the unvalidated AP. If the nonces and mobility domain signatures align, then the unvalidated AP is verified, and the now verified AP can be confidently associated with the mobility domain. A similar process can be done by a client device that receives a beacon from an AP. For example, the client device may verify the unvalidated AP before the client device joins the mobility domain through the unvalidated AP.

In one embodiment, the unvalidated AP is a rogue AP that is mimicking an AP that is associated with the mobility domain. By having an unvalidated AP go through a validation process with an AP associated with the mobility domain, the associated AP can warn devices of the rogue AP before the devices connect to the rogue AP. Also, by having client devices verify APs when the client device is joining the mobility domain, the client devices are less likely to connect to a rogue AP, which enhances security of the client devices data.

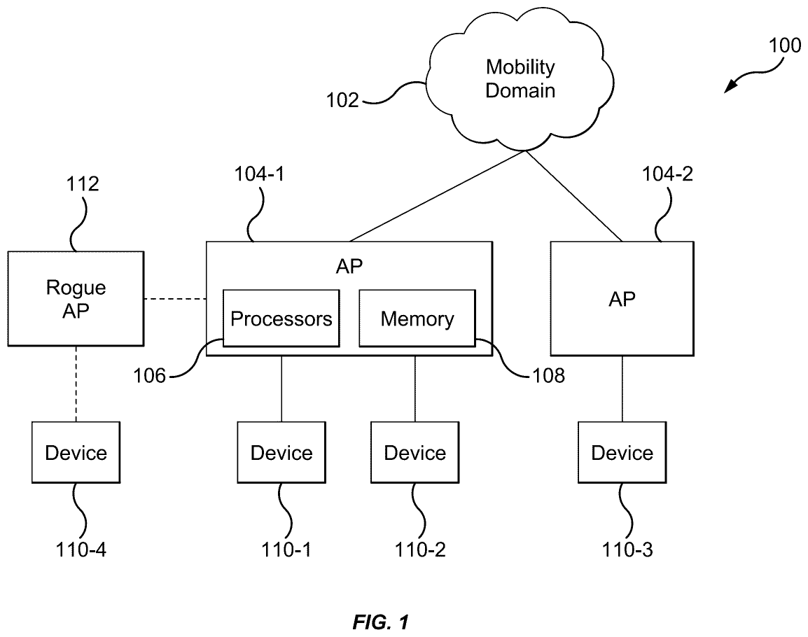

FIG. 1 depicts an environment 100 with a network that has access points and a rogue access point that attempts to mimic one of the access points. In one embodiment, the network includes a configuration of multiple APs acting as or providing a mobility domain. The mobility domain may be a seamless mobility domain (SMD), which includes multiple frequency bands or channels for multiple devices to send data through the mobility domain concurrently. By having an SMD, a device that connects to the SMD can stay connected to the mobility domain without re-authentication when switching between different APs on the SMD. In an illustrated embodiment, a mobility domain 102 corresponds to or is provided by APs 104-1 and 104-2. An AP, such as the APs 104-1 and 104-2, may include processors and memory, such as processors 106 and memory 108 in the AP 104-1. In some embodiments, computing devices such as the devices 110-1 and 110-2 connect to the mobility domain 102 through the AP 104-1 and device 110-3 connects to the mobility domain 102 through the 104-2. Each of the devices 110-1 through 110-3 may be client devices, such as a station (STA) (e.g., a laptop, a desktop computer, a smartphone, a tablet, and the like).

A rogue AP 112 may access a signature of one of the legitimate APs (e.g., the AP 104-1) on a wireless channel used by the AP 104-1 and/or the mobility domain 102 (e.g., in a beacon transmitted by the AP 104-1). When the AP 104-1 stops transmitting on the channel (e.g., because the AP 104-1 is disabled or migrates to another channel), the rogue AP 112 may copy the signature of the AP 104-1 (e.g., to broadcast beacons on the channel). The rogue AP 112 may use the signature to mimic being the AP 104-1, allowing the rogue AP 112 to act as a man-in-the-middle (MITM) between station devices (e.g., the device 110-4) and the mobility domain 102. For example, device 110-4 may attempt to connect to the mobility domain 102 through the rogue AP 112. That is, the device 110-4 may associate with the rogue AP 112, believing that the rogue AP 112 is a legitimate AP to connect to the mobility domain 102.

To reduce the chances of the device 110-4 connecting to the rogue AP 112 when attempting to join the mobility domain 102, APs on the mobility domain 102 may authenticate other APs that advertise themselves as part of the mobility domain 102. In some embodiments, the AP 104-2 similarly advertises itself as being associated with the mobility domain 102. In the illustrated example, other AP(s) associated with the mobility domain 102 (e.g., the AP 104-1) may verify that the AP 104-2 is a valid AP (e.g., is legitimately associated with the mobility domain) as discussed in more detail below. Similarly, suppose the rogue AP 112 advertises itself as part of the mobility domain 102 (e.g., using a stolen signature as discussed above). One or more other APs in the mobility domain (e.g., the AP 104-2) may determine that the rogue AP 112 is not a valid AP (as discussed in more detail below). In one embodiment, to reduce the chances of devices (such as the device 110-4) connecting to the rogue AP 112, the legitimate APs (e.g., the AP 104-1 or the AP 104-2) acts to warn devices (such as the device 110-4) that one or more rogue APs have been detected (e.g., APs purporting to be part of the mobility domain). In response, these devices (e.g., the device 110-4) may use a similar approach to verify APs (e.g., including the rogue AP 112) before connecting to the rogue AP 112.

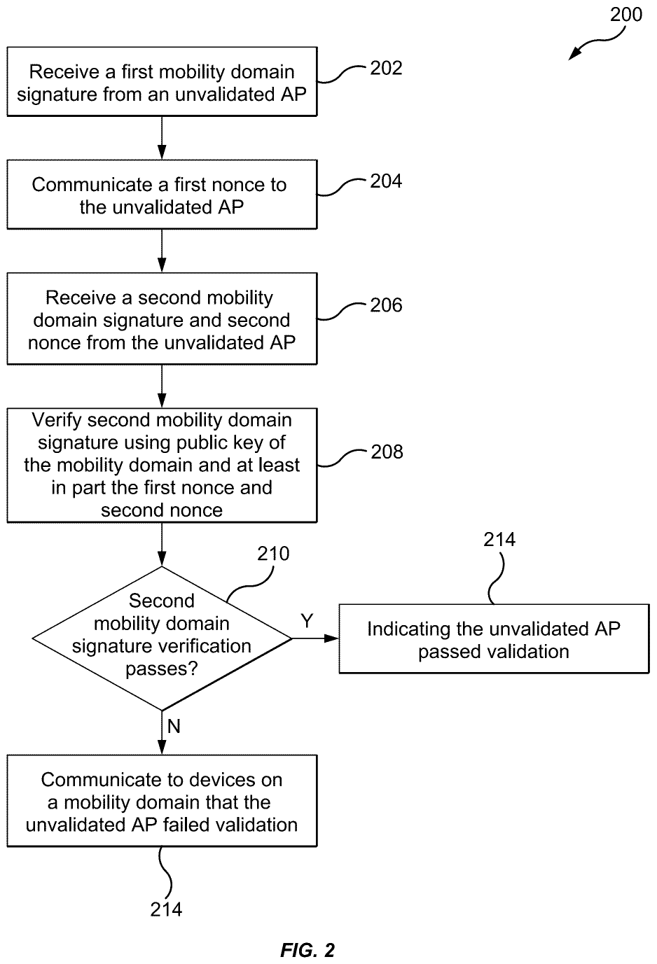

FIG. 2 depicts a method 200 for verifying an unvalidated AP (e.g., the AP 104-2 or the rogue AP 112 in FIG. 1) using an AP that is associated with a mobility domain (e.g., the AP 104-1 associated with the mobility domain 102 in FIG. 1). At block 202, the associated AP receives a first mobility domain signature from the unvalidated AP. For example, the unvalidated AP may transmit a beacon, which contains the first mobility domain signature, indicating that the unvalidated AP is a member of the mobility domain. In some embodiments, the mobility domain signature is generated based in part on an identifier of the mobility domain, as well as an identifier of the AP. In some embodiments, using a public key-private key approach, legitimate APs are configured to generate signatures indicating membership with the mobility domain (e.g., such that the signature can be verified using a known public key of the mobility domain), while non-legitimate APs (that have not been preconfigured as part of the mobility domain) cannot generate valid signatures (e.g., because they do not possess the private key).

In the illustrated example, an AP receiving this beacon may use the first mobility domain signature to attempt to verify the unvalidated AP that advertised the signature. The mobility domain signature can be an identification of an access point and/or mobility domain using any combination of numbers, letters, or symbols.

For verifying the unvalidated AP, the associated AP starts a nonce exchange with the unvalidated AP. At block 204, the associated AP generates a first nonce and communicates the first nonce to the unvalidated AP. The associated AP expects the unvalidated AP to return a new (legitimate) mobility domain signature, which includes the first nonce. In some embodiments, communication between the associated AP and the unvalidated AP could be through access network query protocol (ANQP) public action frames (or another set of public action frames). For example, the associated AP would send an ANQP Query message with the generated first nonce and request the unvalidated AP to generate a mobility domain signature using the first nonce.

At block 206, the associated AP receives a second mobility domain signature from the unvalidated AP. In some embodiments, the second mobility domain signature includes a second nonce that is generated by the unvalidated AP. In some embodiments, the second mobility domain signature includes the first nonce and the second nonce. In some embodiments, the second mobility domain signature is a digital signature generated on the content that includes, in part at least, the first nonce and the second nonce and is generated using the private key of the mobility domain. In some embodiments, the unvalidated AP transmits the second nonce and the second mobility domain signature to the associated AP through an ANQP Response message.

At block 208, the associated AP begins verifying the second mobility domain signature using the mobility domain's public key associated with the mobility domain (e.g., the mobility domain's public key obtained previously for the mobility domain from frames such as a beacon, a probe response, reassociation response, or via an out-of-band mechanism). In some embodiments, verification of the second mobility domain signature at the associated AP involves: the associated AP generating a first hash value from content of a message, which includes in part at least the first nonce and/or the second nonce; the associated AP decrypting the second mobility domain signature using the public key of the mobility domain to obtain a decrypted second hash value; and the associated AP comparing the first hash value with the second hash value. If the two hash values match, then the verification of the second mobility domain signature passes meaning the signature verification is successful. In some embodiments, as discussed above, a legitimate AP (e.g., an AP that is legitimately part of the mobility domain) generates the second mobility domain signature that includes the nonce provided by the associated AP. However, a rogue AP (e.g., the rogue AP 112 in FIG. 1) may be unable to generate the second mobility domain signature (e.g., because it lacks the private key for the corresponding mobility domain). Therefore, the rogue AP can either respond with previously copied mobility domain signature (which will lack the associated AP's fresh nonce), or with a new mobility domain signature including the nonce but that is not generated with the private key corresponding to the mobility domain (and hence it will fail verification).

At block 210, the associated AP determines whether the unvalidated AP passes the mobility domain validation based on verifying the second mobility domain signature. In some embodiments, if the verification for the second mobility domain signature fails, the method 200 moves to block 212. At block 212, the associated AP communicates to client devices (e.g., the devices 110-1 through 110-4 in FIG. 1) on the mobility domain or seeking to join the mobility domain that the unvalidated AP failed validation. That is, the associated AP may notify other devices (e.g., via a flag in beacons and probe responses transmitted by the associated AP) that one or more rogue APs are currently advertising themselves as part of the mobility domain. In some embodiments, this communication alerts the client devices that a rogue AP is mimicking an AP on the mobility domain, and that the client devices should verify that an AP belongs to the mobility domain before connecting with the AP in the mobility domain and/or when roaming to a new AP in the mobility domain. In one embodiment, a bit in a beacon transmitted by the associated AP to the devices indicates that there is a rogue AP mimicking an AP on the mobility domain. In some embodiments, the associated AP indicates the identity of the unvalidated AP in one or more of a beacon frame, a probe response frame, or a fast initial link setup (FILS) discovery frame.

Returning to block 210, if the second mobility domain signature can be verified the method 200 moves to block 214. At block 214, the associated AP determines and/or indicates the verifying AP passed verification (e.g., the unvalidated AP is part of the mobility domain). In one embodiment, where the second mobility domain signature passes the verification process, the associated AP treats the unvalidated AP as part of the mobility domain (e.g., refraining from warning other devices that a rogue AP is present).

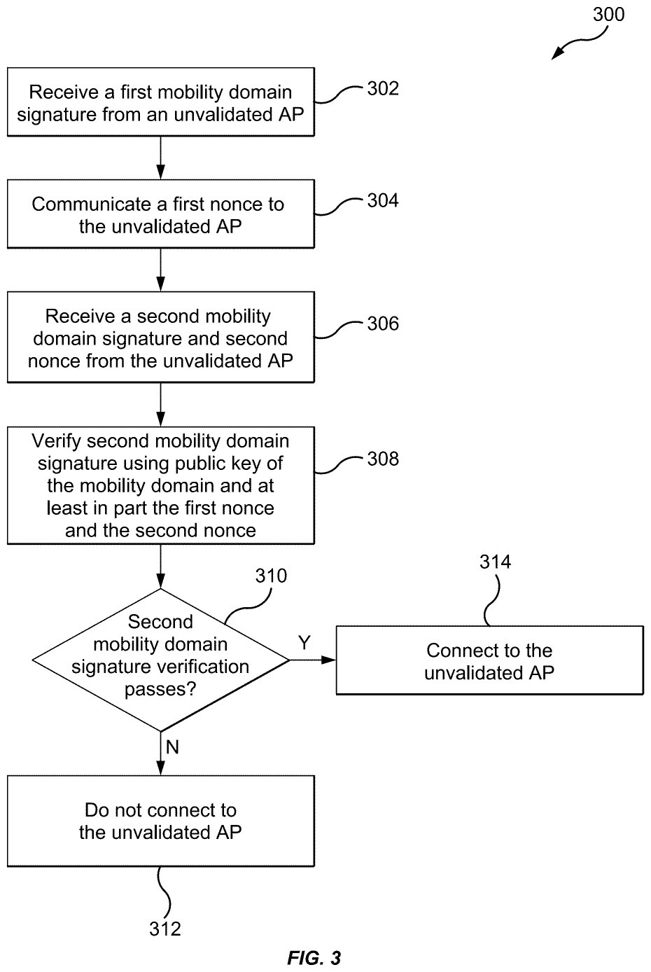

While FIG. 2 depicts AP verification from the perspective of an AP verifying another AP, FIG. 3 depicts a method 300 for verifying an unvalidated AP (e.g., the AP 104-2 in FIG. 1) by a client device (e.g., the devices 110-1 through 110-4 in FIG. 1). In one embodiment, a client device performs the method 300 to verify an AP in response to being informed that there is a rogue AP (e.g., the rogue AP 112 in FIG. 1) mimicking an AP on a mobility domain that the client device is attempting to join (or has already joined).

At block 302, the client device receives a first mobility domain signature from the unvalidated AP. For example, the unvalidated AP may transmit a beacon, which contains the first mobility domain signature, indicating that the unvalidated AP is available and supports the mobility domain. The client device uses the first mobility domain signature to begin verifying the unvalidated AP.

At block 304, the client device communicates a first nonce to the unvalidated AP. For verifying the unvalidated AP, the client device starts a nonce exchange with the unvalidated AP. In one embodiment, the client device generates the first nonce and transmits the first nonce to the unvalidated AP. As discussed above, the client device expects a new mobility domain signature from the unvalidated AP, which is generated on a message content that includes in part at least the first nonce.

At block 306, the client device receives a second mobility domain signature from the unvalidated AP. In one embodiment, the second mobility domain signature generation also includes a second nonce that is generated by the unvalidated AP. In one embodiment, the second mobility domain signature includes the first nonce and the second nonce. The second nonce is added to signature generation by the unvalidated AP to prove liveness of the signature generation and avoids replay of the signature in future.

At block 308, the client device begins verifying the second mobility domain signature using the mobility domain's public key associated with the mobility domain (e.g., the mobility domain's public key it obtained previously for the mobility domain from frames such as a beacon, a probe response, reassociation response, or via an out-of-band mechanism). In some embodiments, verification of the second mobility domain signature at the client device involves: the client device generating a first hash value from content of a message, which includes in part at least the first nonce and/or the second nonce; the client device decrypting the second mobility domain signature using the public key of the mobility domain to obtain a decrypted second hash value; and the client device comparing the first hash value with the second hash value. If the two hash values match, then the verification of the second mobility domain signature passes meaning the signature verification is successful. In some embodiments, as discussed above, a legitimate AP (e.g., an AP that is legitimately part of the mobility domain) generates the second mobility domain signature that includes the nonce provided by the client device. However, a rogue AP (e.g., the rogue AP 112 in FIG. 1) may be unable to generate the second mobility domain signature (e.g., because it lacks the private key for the corresponding mobility domain). Therefore, the rogue AP can either respond with previously copied mobility domain signature (which will lack the client device's fresh nonce), or with a new mobility domain signature including the nonce but that is not generated with the private key corresponding to the mobility domain (and hence it will fail verification).

At block 310, the client device determines whether the unvalidated AP passes the mobility domain validation based on verifying the second mobility domain signature. In some embodiments, if the verification for the second mobility domain signature fails, the method 300 moves to block 312. At block 312, the client device does not connect to the mobility domain through the unvalidated AP. That is, the client device may determine that the unvalidated AP is likely a rogue AP, and may therefore determine not to connect to the unvalidated AP. In one embodiment, the client device retries connecting to the mobility domain on another AP. In some embodiments, the client device notifies or advertise to other device(s) that a rogue AP is present, as discussed above (e.g., using broadcast frames and/or unicast frames to a legitimate AP).

Returning to block 310, if the second domain signature is verified by the client device, the method 300 moves to block 314. At block 314, the client device connects to the mobility domain through the previously unvalidated AP.

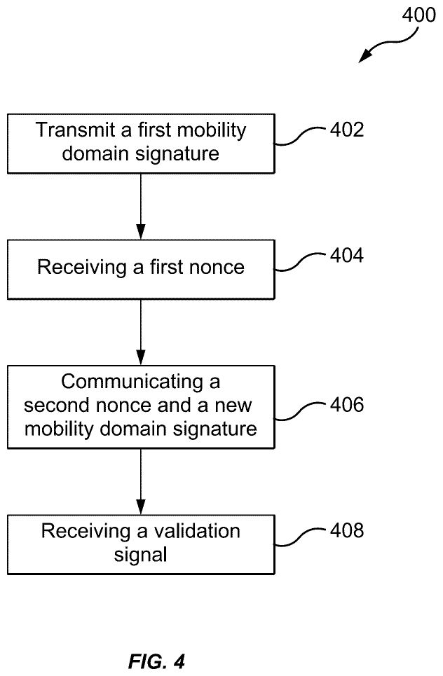

FIG. 4 depicts a method 400 for an AP (e.g., the AP 104-1 in FIG. 1) to verify itself as part of a mobility domain (e.g., the mobility domain 102 in FIG. 1). At block 402, the AP transmits a first mobility domain signature, such as in a beacon, to advertise the AP's membership in the mobility domain.

At block 404, the AP receives a first nonce from a recipient device (e.g., another AP, or a client device), where the recipient device is challenging the AP to prove it is legitimately part of the mobility domain. This triggers a nonce exchange between the AP and the other device to verify the AP.

At block 406, the AP generates a new mobility domain signature (e.g., using the private key of the mobility domain) including and/or based on the received first nonce, and communicates the new mobility domain signature to the requesting device (e.g., the recipient device). In some embodiments, the new mobility domain signature can also include and/or be generated based on a second nonce generated by the AP. In some embodiments, as discussed above, the new mobility domain signature includes data that can be verified using a public key that is associated with the mobility domain.

At block 408, the AP optionally receives a validation signal. For example, the validation signal may include the recipient device associating to the mobility domain via the AP (e.g., once the AP is validated), as discussed above confirming that the mobility domain verification was successful for the AP.

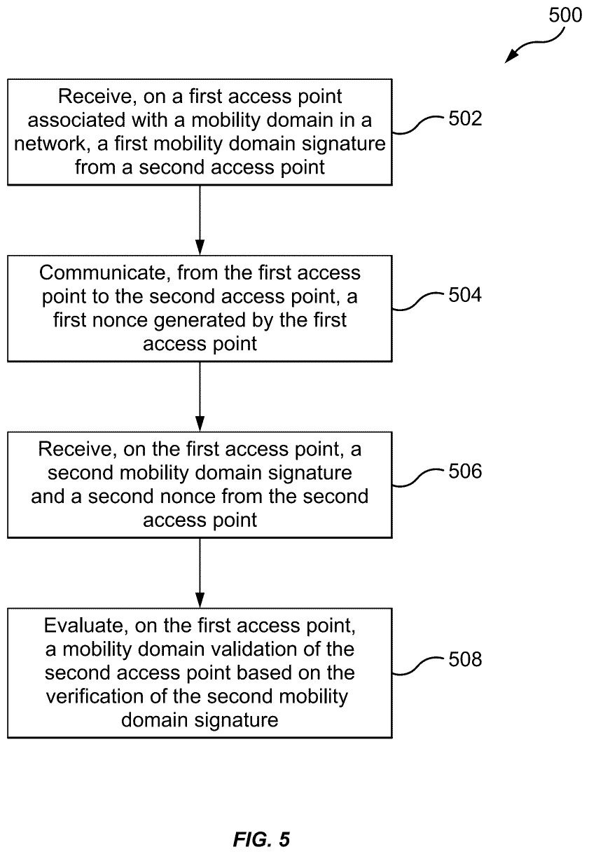

FIG. 5 is a flowchart depicting an example method 500 for validating an unvalidated AP with a validated AP, according to some embodiments of the present disclosure.

At block 502, an AP (e.g., the AP 104-1 in FIG. 1) associated with a mobility domain (e.g., the mobility domain 102 in FIG. 1) in a network receives a first mobility domain signature from a second access point (e.g., the AP 104-2 in FIG. 1).

At block 504, the AP communicates to the second access point, a first nonce generated by the AP.

At block 506, the AP receives a second mobility domain signature and a second nonce from the second access point.

At block 508, the AP evaluates a mobility domain validation of the second access point based on verification of the second mobility domain signature.

In some embodiments, the second mobility domain signature is a digital signature generated based on at least the first nonce, the second nonce, and a private key of the mobility domain.

In some embodiments, the verification of the second mobility domain signature comprises verifying the digital signature based on at least the first nonce, the second nonce, and a public key of the mobility domain.

In some embodiments, the mobility domain is an SMD, and wherein the first AP and the second AP are advertised to be part of the SMD.

In some embodiments, the AP, in response to determining that the verification of the second mobility domain signature fails, broadcasting, by the first access point, a signal indicating the network includes an access point that has failed the mobility domain validation.

In some embodiments, the AP indicates in the broadcasted signal an identity of the second access point that has failed the mobility domain validation.

In some embodiments, the AP broadcasts a second signal instructing a first device (e.g., the device 110-4) receiving the signal from the first access point to perform mobility domain validation for access points that the first device attempts to connect to.

In some embodiments, broadcasting the signal includes sending the signal in one or more of a beacon frame, a probe response frame, or a FILS discovery frame.

In some embodiments, communication between the first access point and the second access point for the mobility domain validation is performed using an ANQP.

In some embodiments, the AP transmits a third mobility domain signature, receives a third nonce, generates a fourth mobility domain signature based in part on the third nonce, and transmits the fourth mobility domain signature.

In some embodiments, the AP, in response to determining that the second mobility domain signature passes, determining that the second access point passed the mobility domain validation.

In some embodiments, the AP, in response to determining that the second access point passed the mobility domain validation, transmitting an indication that the second access point is a validated member of the mobility domain in the network.

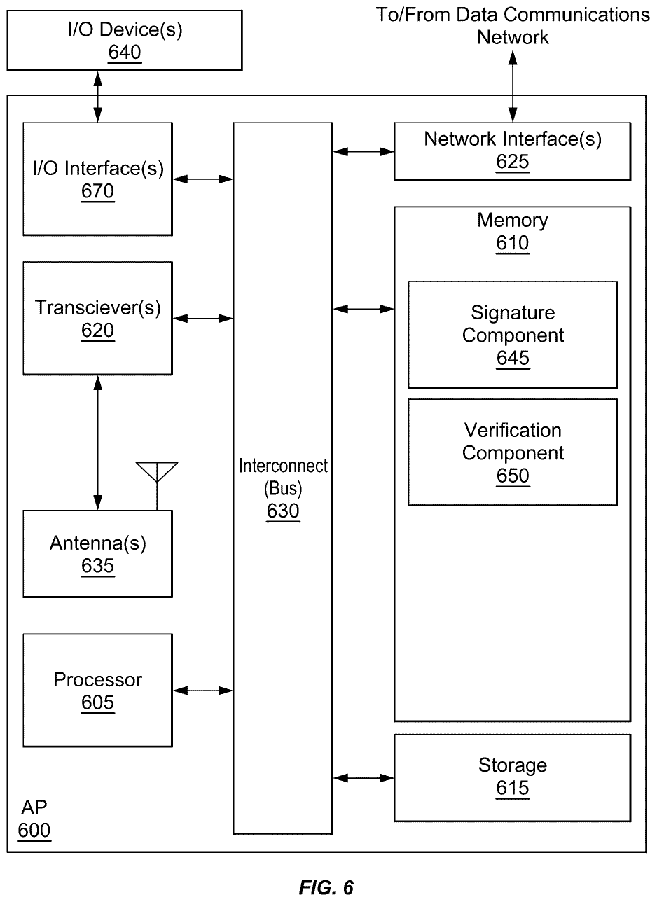

FIG. 6 depicts an example network device 600 configured to perform various aspects of the present disclosure, according to some aspects of the present disclosure. The network device 600 may be an AP, which corresponds to the APs 104-1 and 104-2 as depicted in FIG. 1.

As illustrated, the example network device 600 includes a processor 605, memory 610, storage 615, one or more transceivers 620, one or more I/O interfaces 680, and one or more network interfaces 625. In some embodiments, I/O devices 640 are connected via the I/O interface(s) 680. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 680, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. In the illustrated example, the memory 610 includes two software components: signature component 645 and verification component 650.

In one embodiment, the signature component 645 is configured to generate mobility domain signatures. In one embodiment, the signature component 645 generates a mobility domain signature based on a generated nonce. In one embodiment, the signature component 645 generates the mobility domain signature based on a public key for a mobility domain. In one embodiment, the signature component 645 receives a nonce from an external source and includes the nonce in the generated mobility domain signature. In some embodiments, the signature component 645 generates the mobility domain signature with a combination of the different embodiments described above.

In one embodiment, the verification component 650 is configured to verify other devices and be verified by other devices. More specifically, the verification component 650 may be used to do the verification method described above for an AP (e.g., verifying the AP 104-2 in FIG. 1) and the verification component 650 may be used for verifying the network device 600 when it is unvalidated.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments, and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method, or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, on a first access point associated with a mobility domain in a network, a first mobility domain signature from a second access point;
communicating, from the first access point to the second access point, a first nonce generated by the first access point;
receiving, on the first access point, a second mobility domain signature and a second nonce from the second access point; and
evaluating, on the first access point, a mobility domain validation of the second access point based on verification of the second mobility domain signature.

2. The method of claim 1, wherein the second mobility domain signature is a digital signature generated based on at least the first nonce, the second nonce, and a private key of the mobility domain.

3. The method of claim 2, wherein the verification of the second mobility domain signature comprises verifying the digital signature based on at least the first nonce, the second nonce, and a public key of the mobility domain.

4. The method of claim 1, wherein the mobility domain is a seamless mobility domain (SMD), and wherein the first access point and the second access point are advertised to be part of the SMD.

5. The method of claim 1, further comprising:
responsive to determining that the verification of the second mobility domain signature fails, broadcasting, by the first access point, a signal indicating the network includes an access point that has failed the mobility domain validation.

6. The method of claim 5, further comprising indicating in the broadcasted signal an identity of the second access point that has failed the mobility domain validation.

7. The method of claim 6, further comprising:
broadcasting a second signal instructing a first device receiving the signal from the first access point to perform mobility domain validation for access points that the first device attempts to connect to.

8. The method of claim 7, wherein broadcasting the signal includes sending the signal in one or more of a beacon frame, a probe response frame, or a fast initial link setup (FILS) discovery frame.

9. The method of claim 1, wherein communication between the first access point and the second access point for the mobility domain validation is performed using an access network query protocol (ANQP).

10. The method of claim 1, further comprising:
transmitting, by the first access point, a third mobility domain signature;
receiving, by the first access point, a third nonce;
generating, by the first access point, a fourth mobility domain signature based in part on the third nonce; and
transmitting, by the first access point, the fourth mobility domain signature.

11. The method of claim 3, further comprising:
responsive to determining that the verification of the second mobility domain signature passes, determining, by the first access point, that the second access point passed the mobility domain validation.

12. The method of claim 11, further comprising:
responsive to determining that the second access point passed the mobility domain validation, transmitting, by the first access point, an indication that the second access point is a validated member of the mobility domain in the network.

13. A system comprising:
one or more memories; and
one or more processors communicatively coupled to the one or more memories, wherein the one or more processors are configured to, individually or collectively, perform operations comprising:
receiving a first mobility domain signature from a second access point;
communicating, to the second access point, a generated first nonce;
receiving a second mobility domain signature and a second nonce from the second access point; and
evaluating a mobility domain validation of the second access point based on verification of the second mobility domain signature.

14. The system of claim 13, further comprising:
responsive to determining that the verification of the second mobility domain signature fails, broadcasting a signal indicating a network includes an access point that has failed mobility domain verification.

15. The system of claim 14, further comprising:
broadcasting a second signal instructing a first device receiving the signal to perform mobility domain validation for access points that the first device attempts to connect to.

16. The system of claim 15, further comprising indicating in the broadcasted signal an identity of the second access point that has failed the mobility domain validation.

17. A non-transitory computer-readable medium containing computer program code that, when executed by operation of one or more computer processors, performs operations comprising:
receiving a first mobility domain signature from a second access point;
communicating, to the second access point, a generated first nonce;
receiving a second mobility domain signature and a second nonce from the second access point; and
evaluating a mobility domain validation of the second access point based on verification of the second mobility domain signature.

18. The non-transitory computer-readable medium of claim 17, further comprising:
responsive to determining that the verification of the second mobility domain signature fails, broadcasting a signal indicating a network includes an access point that has failed mobility domain verification.

19. The non-transitory computer-readable medium of claim 18, further comprising:
broadcasting a second signal instructing a first device receiving the signal to perform mobility domain validation for access points that the first device attempts to connect to.

20. The non-transitory computer-readable medium of claim 19, further comprising indicating in the broadcasted signal an identity of the second access point that has failed the mobility domain validation.
